(19) United States
(12) Patent Application Publication
(10) Pub. No.: US 2002/0158359 A1
(43) Pub. Date: Oct. 31, 2002

(54) Method of monitoring die opening force in an electric injection molding machine

(76) Inventors: Haruyuki Matsubayashi, Numazu-shi (JP); Takashi Yamazaki, Mishima-shi (JP); Makoto Nishizawa, Numazu-shi (JP); Masamitsu Suzuki, Numazu-shi (JP); Motoyuki Miyauchi, Shizuoka-ken (JP); Yutaka Yamaguchi, Shizuoka-ken (JP)

Correspondence Address: Pillsbury Winthrop LLP, 1600 Tysons Boulevard, McLean, VA, 22102, US

(21) Appl. No.: 10/119,712

(22) Filed: Apr. 11, 2002

(30) Foreign Application Priority Data
Apr. 27, 2001 (JP) 2001-133143

(51) Int. Cl. B29C 45/76

(52) U.S. Cl. 264/40.1; 264/328.1

(57) ABSTRACT

An object of the present invention is to provide a method of preventing the failure of dies to open because of insufficient die opening force in an electric injection molding machine. A stationary die is attached to a stationary platen, whereas a movable die is attached to the front surface of a movable platen. The movable platen moves along the clamping and unclamping operation by a toggle mechanism. The toggle mechanism is expanded or contracted by a servo motor via a crosshead. A control section controls the operation of the servomotor by sending data of the crosshead position as a feed-back signal. A comparison unit compares a measured torque value of the servomotor with the upper limit value previously set and displays a warning on a display unit when the measured value exceeds the upper limit.

### CROSS-REFERENCE TO RELATED APPLICATIONS

This application is based upon and claims the benefit of priority from the prior Japanese Patent Application No. 2001-133143, filed Apr. 27, 2001, the entire contents of which are incorporated herein by reference.

### BACKGROUND OF THE INVENTION

1. Field of the Invention

The present invention relates to an electric injection-molding machine, and more specifically, to a method of preventing the failure of dies to open because of insufficient die opening force.

2. Description of the Related Art

In a conventional electric injection molding machine, dies are opened while monitoring the force applied to the dies. More specifically, the dies are opened while monitoring the torque curve (or numerical torque value) of a die open-and-close servomotor, the torque curve being displayed on a control panel. However, a means to indicate in advance that the dies will fail to open because of insufficient die opening force (i.e., insufficient torque of the servomotor) is not provided in the conventional electric injection molding machine.

When a product which requires large force to open the dies is manufactured by an injection-molding machine, the required opening force may sometimes exceed the available opening force, with the result that the dies cannot be opened. In such a case, the dies must be transferred to another injection molding machine and opened by applying a larger opening force or they must be broken to remove a molded product.

In the case to begin commercial production of new product with an injection molding machine, molding conditions are determined in advance. The amount of molten resin to be packed in the dies may be increased to prevent short shots and sink marks (surface hollows) on the molded product. However, the larger the amount of the molten resin is used, the larger the force is required to open the dies. When molten resin is excessively packed in the dies (called over-pack condition), the die opening force applied by the injection-molding machine will be insufficient to open the dies. In such a case, even if a means for displaying the die opening force (that is, the torque of the die open-and-close servomotor) is provided to the injection-molding machine, the careless operator cannot predict that the dies fail to open. As a result, the dies fail to open even if the maximum instantaneous torque (or the maximum instantaneous torque corresponding to the mechanical strength of a ball screw to drive a movable die) is applied to the dies by the servomotor of the injection-molding machine.

### BRIEF SUMMARY OF THE INVENTION

The present invention has been made in view of the aforementioned problem regarding opening the dies of a conventional electric injection-molding machine. An object of the present invention is to provide a method of predicting the dies failing to open because of insufficient die opening force, thereby preventing such an occurrence.

According to the present invention, there is provided a method of monitoring die-opening force of an electric injection molding machine comprising:

monitoring torque of a die open-and-close servomotor while opening dies; and

generating an alarm when the torque reaches or exceeds a predetermined upper limit.

Note that it is necessary to set an appropriate value for the upper limit according to the maximum instantaneous torque obtainable from the die open-and-close servomotor. For example, the upper limit is preferably less than the maximum instantaneous torque described in the specification of the open-and-close servomotor and not more than the maximum instantaneous torque corresponding to the mechanical strength of the ball screw to drive a movable die.

According to the die opening force monitoring method for an electric injection molding machine of the present invention, when the proper packing amount of molten resin is determined while adjusting the amount to be packed in the die, it is possible to warn the operator that the die opening force will not be sufficient (close to the limit value) before the dies fail to open even if the maximum instantaneous torque of the servomotor (or the maximum instantaneous torque corresponding to a mechanical strength of a ball screw to drive a movable die) is applied. As a result, it is possible not only to prevent excessive packing of molten resin but also to reduce the occurrence of trouble, that is, failure to open dies.

### BRIEF DESCRIPTION OF THE SEVERAL VIEWS OF THE DRAWING

FIG. 1 is a block diagram of a system when the monitoring method of the present invention is applied to an injection molding machine equipped with a die clamping machine having an electric toggle mechanism; and

FIG. 2 is a flowchart showing the method of monitoring die opening force according to the present invention.

### DETAILED DESCRIPTION OF THE INVENTION

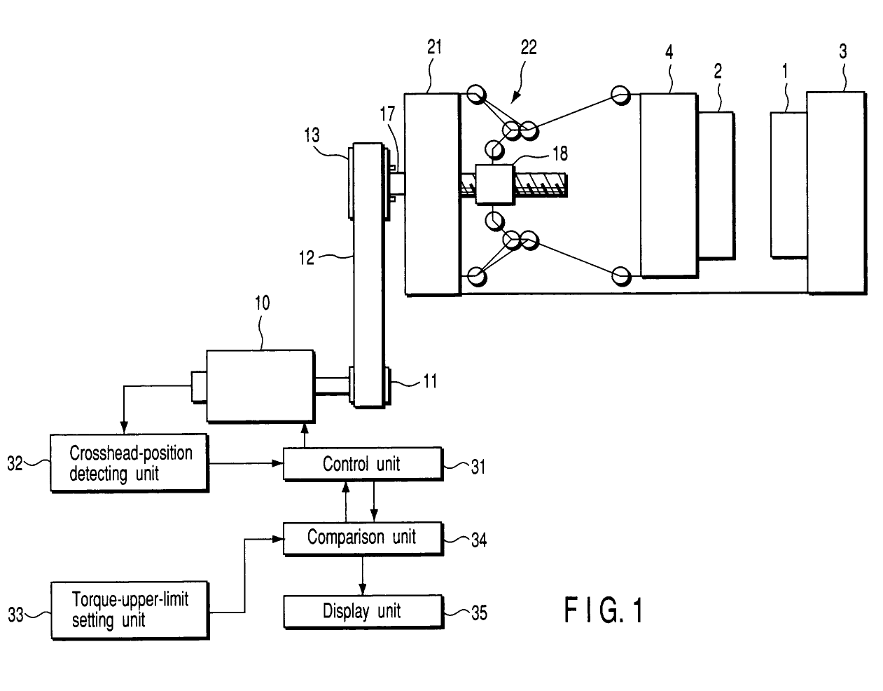

FIG. 1 shows an electric injection-molding machine to which the method of monitoring die opening force according to the present invention is applied.

The injection molding machine is equipped with a die clamping machine having an electric toggle mechanism. A stationary platen 3 is arranged so as to face a movable platen 4. A stationary die 1 is attached on the front surface of the stationary platen 3, whereas a movable die 2 is attached on the front surface of the movable platen 4. The movable platen 4 is attached to the front surface of a link housing 21 via a toggle mechanism 22. The toggle mechanism 22 is expanded and contracted by a crosshead 18 driven by a feed screw 17, thereby controlling the open-and-close movement of the movable platen 4. The feed screw 17 is driven by a servomotor 10. A pulley 11 is attached to the tip of the shaft of the servomotor 10. A pulley 13 is attached to the rear end portion of the feed screw 17. The pulley 11 and the pulley 13 are coupled to each other by a timing belt 12.

The crosshead position detecting unit 32 calculates a crosshead position based on the amount of rotation of a servomotor 10 to obtain data, which is sent to a control unit 31. The control unit 31 sends the data of the crosshead position as a feed-back signal in the form of an electric signal and controls the operation of the servomotor 10 according to a predetermined program.

The upper limit of driving torque of a servomotor 10 is set at a torque upper limit setting unit 33 by the operator. A comparison unit 34 compares a measured driving torque of the servomotor 10 sent from the controlling unit 31 to the upper limit of the driving torque sent from the torque upper limit setting unit 33. When the measurement torque value exceeds the upper limit, an alarm beep is generated. At the same time, a warning is displayed on the display unit 35 to alert the operator.

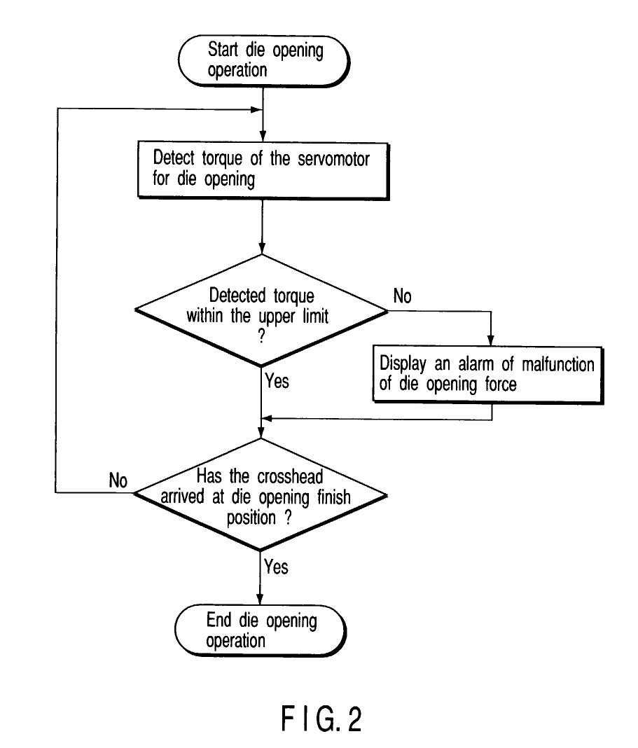

FIG. 2 shows a flowchart of the method of monitoring die opening force according to the present invention.

After the operation of die opening is started, the monitoring of the torque value of the die open-and-close servomotor 10 is started. The detected torque is compared to a predetermined upper value. If the detected value does not exceed the predetermined upper limit, the flow goes to the step of determining whether or not a crosshead position arrives at a die opening completion position. When the crosshead position does not arrive at the die opening completion position, the flow returns to the stating point of the loop. When the crosshead position arrives at the die opening completion position, die opening operation is terminated.

When the detected torque of the die open-and-close servomotor 10 exceeds the predetermined upper limit, warning of “the die opening force exceeds the upper limit” is displayed on the display unit 35 (FIG. 1). Thereafter, the flow goes to the step of determining whether or not the crosshead position arrives at the die opening completion position.

The operator made fully aware of the fact, by the warning, that the die opening force is approaching the value (critical point) beyond which dies fail to open even if a force is applied by the die open-and-close servomotor 10 (FIG. 1). This means that a molten resin may be packed excessively. However, at that time, the opening force applied by the die open-and-close servomotor 10 is still capable to open the die. Therefore, the die open-and-close servomotor 10 continues to apply the force to the die until it finishes the die opening operation. After the dies are opened, the operator adjusts the packing amount of resin for the next production.

The aforementioned method may be modified as follows: When the torque of a servomotor for opening the dies exceeds the upper limit, a warning is displayed and simultaneously a servomotor may be temporarily stopped. At this time, the operator must determine whether to continue the die opening operation or remove the dies from the machine in use.

In the embodiment explained above, the monitoring method of the present invention is applied to an injection molding machine equipped with a die clamping system using a toggle mechanism; however it may be applied to an injection molding machine having a die clamping system directly driven without using a toggle mechanism.

According to the method of die opening force for an electric injection molding machine of the present invention, when an appropriate packing amount of molten resin is determined while adjusting the amount to be packed in dies, it is possible to make it known to the operator that die opening force is not sufficient before the dies fail to open even if the maximum instantaneous torque of the servomotor (or the maximum instantaneous torque corresponding to a mechanical strength of a ball screw to drive a movable die) is applied. As a result, it is possible not only to prevent excessive packing of molten resin but also to reduce the occurrence of trouble, that is, a failure of opening dies.

What is claimed is:

1. A method of monitoring die-opening force of an electric injection molding machine, comprising:
monitoring torque of a die open-and-close servomotor while opening dies; and
generating an alarm when the torque reaches or exceeds a predetermined upper limit.

2. A method according to claim 1, wherein said upper limit is less than the maximum instantaneous torque described in the specification of said open-and-close servomotor.
